(19) United States
(12) Patent Application Publication
(10) Pub. No.: US 2013/0150984 A1
(43) Pub. Date: Jun. 13, 2013

(54) TEST SYSTEM WITH CONFIGURABLE CLOSED LOOP

(71) Applicants: Richard M. Nigro, North Ridgeville, OH (US); Gregory E. Wehrung, North Royalton, OH (US); Daniel P. Glynn, Middleburg Heights, OH (US); Christopher F. Oleksy, Solon, OH (US)

(72) Inventors: Richard M. Nigro, North Ridgeville, OH (US); Gregory E. Wehrung, North Royalton, OH (US); Daniel P. Glynn, Middleburg Heights, OH (US); Christopher F. Oleksy, Solon, OH (US)

(21) Appl. No.: 13/324,270

(22) Filed: Dec. 13, 2011

(51) Int. Cl. G05B 13/02

(52) U.S. Cl. 700/37; 700/45

(57) ABSTRACT

A test system can comprise a controller configured to provide a closed loop. The closed loop can comprise a forward transfer function with programmable coefficients that is configured to receive a signal corresponding to a command signal. The closed loop can also comprise a feedback transfer function having programmable coefficients and can be configured to provide a feedback signal that is subtracted from the command signal. The controller can be configured to provide a control signal corresponding to an output of the forward transfer function.

### TECHNICAL FIELD

This invention relates to a system with a closed loop. More particularly, this invention relates to a test system with a configurable closed loop.

### BACKGROUND

Automated Test Equipment (ATE) is used in many industries to efficiently test various electrical and electromechanical devices. For example, manufacturers seek to reduce production time while still achieving a quality for equipment, and the test equipment facilitates testing the operation of equipment and devices for their intended purposes. Test equipment is usually configured to test functionality for certain equipment within a given industry, and sometimes is manufactured specifically to test a particular piece of equipment, which tends to increase the cost of the test equipment. Depending of the complexity of the equipment being tested, the actual testing itself can become quite complicated, requiring significant expertise to operate the test equipment.

### SUMMARY

One example relates to a test system that can comprise a controller configured to provide a closed loop. The closed loop can comprise a forward transfer function with programmable coefficients that is configured to receive a signal corresponding to a command signal. The closed loop can also comprise a feedback transfer function having programmable coefficients and can be configured to provide a feedback signal that is subtracted from the command signal. The controller can be configured to provide a control signal corresponding to an output of the forward transfer function.

Another example relates to a test system for configuring a closed loop. The closed loop can comprise a controller configured to provide a closed loop, the closed loop configured to receive at least one command signal. The controller can comprise a proportional-integral-derivative (PID) controller with programmable constants. The controller can also comprise a forward transfer function with programmable coefficients that is configured to receive an output of the PID controller. The controller can further comprise a feedback transfer function having programmable coefficients and being configured to provide a feedback signal to the PID controller. The controller can be configured to provide a control signal corresponding to an output of the forward transfer function. The closed loop can further comprise an interface configured to provide an electrical signal to an output for operating a unit under test (UUT) as a function of the electrical signal.

Yet another example relates to a method for configuring a test system. The method can comprise selecting a feedback signal for a closed loop from a plurality of feedback signals. The method can also comprise setting transfer function parameters in a transfer function of a controller for the closed loop. The method can further comprise setting PID controller parameters for a PID controller of the controller for the closed loop.

### BRIEF DESCRIPTION OF THE DRAWINGS

FIG. 1 illustrates an example of a test system.

FIG. 2 illustrates another example of a closed loop test system.

FIG. 3 illustrates an example of a proportional-integral-derivative (PID) controller.

FIG. 4 illustrates an example of part of a system that includes a plurality of closed loops.

FIG. 5 illustrates an example flowchart of a method for configuring a closed loop test system.

### DETAILED DESCRIPTION

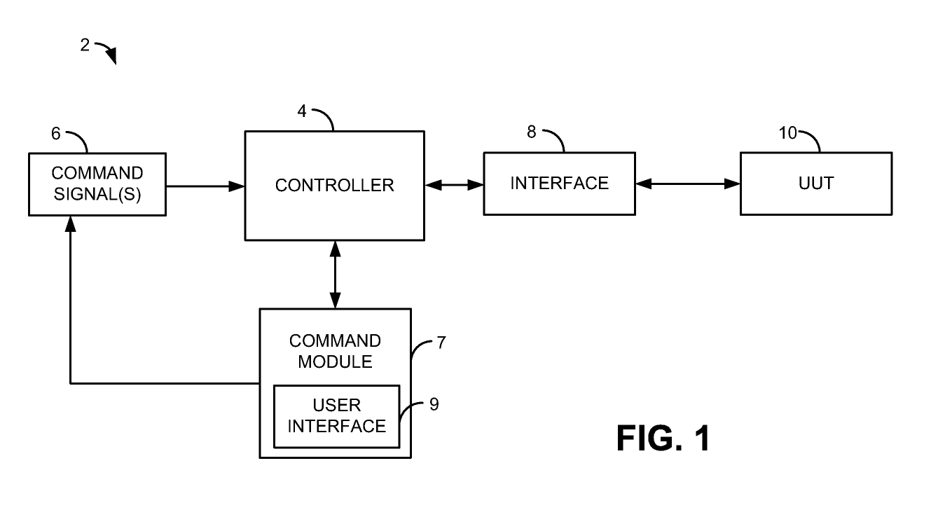

FIG. 1 illustrates an example of a test system 2 for implementing a closed loop. The system 2 can include a controller 4 that can receive one or more command signals 6. The controller 4 could be implemented, for example, as a field programmable gate array (FPGA), a microcontroller, an application specific integrated circuit (ASIC) or the like. The one or more command signals 6 can be analog input signals. In some examples, there can be two command signals 6. In such a situation, a first of the two command signals 6 can be a relatively constant input signal, while a second of the two command signals 6 can vary. In other examples, more or less command signals 6 could be employed.

In some examples, the one or more command signals can be provided from and/or controlled by a command module 7. The command module 7 could be implemented, for example, by a human-machine interface, such as a computer. The command module 7 can be programmed/configured for manual and/or automatic operation. The automatic operation can include automatic application and verification of a test stimulus. The command module 7 can include a user interface 9 that can be configured to provide user input and output. By employing the user interface 9, a user can select preprogrammed test routines. Such test routines can provide precise, repeatable testing to reduce and/or eliminate errors.

The controller 4 can be configured to communicate with a unit under test (UUT) 10 via an interface 8. The UUT 10 could be implemented, for example, as a mechanical structure, an electromechanical device or an electrical device. As one example, the UUT 10 may be implemented as an aircraft, or some portion thereof. In some examples, the controller 4 can provide a control signal to a current driver of the interface 8. The control signal could be implemented as a digital signal or an analog signal. In response, the interface 8 can provide a control current corresponding to the control signal to circuitry (e.g., an actuator) in the UUT 10. In some examples, the actuator could be implemented as an electro-hydraulic valve (EHV). In other examples, the actuator could be implemented as a rotary actuator or a piston. Those skilled will understand other types of actuators and types of UUTs that may be utilized in the system of FIG. 1.

The interface 8 can include an input configured to receive an analog feedback signal from the UUT 10. In some examples, the analog feedback signal can be provided from a linear variable differential transformer (LVDT) or other circuitry configured to provide feedback from the UUT to the test system 2. The analog feedback signal can be implemented, for example, as an AC signal with a magnitude and/or phase corresponding to a position of an actuator detected by the LVDT. In other examples, the analog feedback signal could correspond to a pressure signal, a rotary encoder or other measurement device or related signals. The interface 8 can also include a demodulator that converts the analog feedback signal to a corresponding DC feedback signal. The DC feedback signal can be provided to the controller 4. In some examples, the interface 8 can provide multiple DC feedback signals to the controller 4. Analog-to-digital conversion may be utilized to provide the feedback signal as a corresponding digital signal.

By way of example, the controller 4 can be configured to apply a transfer function to the DC feedback signal. In some examples, the controller 4 can apply multiple transfer functions to a plurality of different DC feedback signals. The controller 4 can also apply a programmable amount of gain to an output of the transfer function applied to the DC feedback signal.

The controller 4 can also provide a gain to each of the command signals 6. The command signals 6 with the added gain can be provided to a proportional-integral-derivative (PID) controller of the controller 4. The PID controller could be implemented, for example, to simulate operation of a control loop feedback controller. For example, the PID controller can apply three programmable constants (e.g., parameters), namely, a proportional constant (Kₚ) an integral constant (Kᵢ) and a derivative constant (K_{d}). Each of the proportional constant, the integral constant and the derivative constant can be programmed by a user employing the user interface 9 of the command module 7. The PID controller can sum (i) a proportional term (Pₜₑᵣₘ) that employs the proportional constant, an integral term (Iₜₑᵣₘ) that employs the integral constant and a derivative term (Dₜₑᵣₘ) that employs the derivative constant to provide a PID signal.

The controller 4 can also apply a forward transfer function to the PID signal to provide a processed signal. The forward transfer function can be implemented as a series of variables with coefficients. Each of the coefficients (e.g., parameters) can be programmed via the user interface 9 of the command module. The controller 4 can also apply a dithering function to the process signal to provide a dithered process signal. Parameters of the dithering function, such as frequency (e.g., 0 Hz to 400 Hz) and magnitude (e.g., 0 V to 10 V) can be programmed via the user interface 9 of the command module 7.

The dithered process signal can be provided a control signal to the interface 8. The interface 8 can include a current driver that can provide the control current to the UUT 10 that corresponds to the dithered process signal. An output limit of the current driver can be controlled, for example, in response to being set by the user of the system 2. The output limit can define a current limit that can characterize a maximum positive and negative amplitude of the control current output by the current driver of the interface 8. The actuator (or the structure) of the UUT 10 can be characterized by the analog feedback signal provided from the UUT 10.

Parameters of the controller 4, such as including coefficients of the PID controller, the forward transfer function and the feedback transfer can be set and/or changed by command module 7 in response to user input at the user interface 9. In some examples, the command module can set and/or change the gain of the controller 4 in response to user input at the user interface 9. Additionally or alternatively, the command module 7 can select a source of a DC feedback signal employed by the controller 4 in response to user input at the user interface 9.

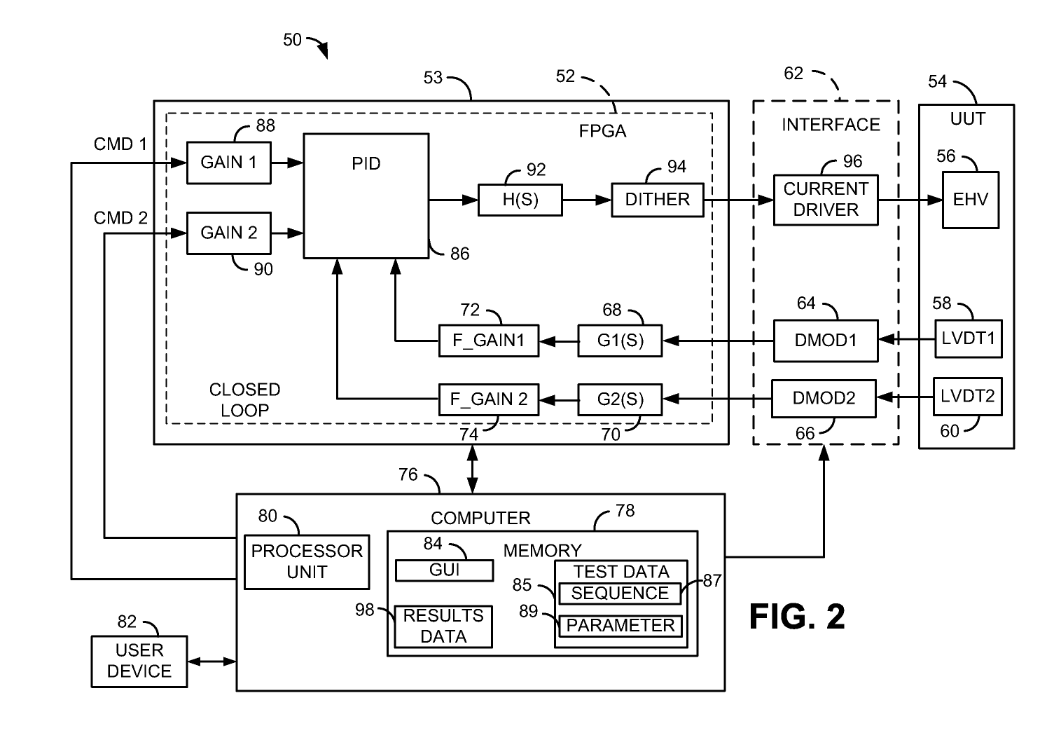

FIG. 2 illustrates another example of a system 50 for implementing a closed loop 52. The closed loop 52 could be implemented on an FPGA 53. It is to be understood that in other examples, the closed loop 52 could be implemented on a different type of circuit, such as a microcontroller, an ASIC or the like. The closed loop 52 can be employed, for example, to generate signals corresponding to a predetermined transfer function for controlling a UUT 54. In some examples, the UUT 54 could be implemented to include an EHV 56. The UUT 54 can provide a first LVDT signal from a first LVDT 58 (labeled in FIG. 2 as “LVDT1”) and a second LVDT signal from a second LDVT 60 (labeled in FIG. 2 as “LVDT2”). The first and second LVDT signals can characterize a position of the EHV 56 or other operating condition of the UUT 54, more generally. The first and second LVDT signals can be provided to an interface 62. The interface 62 could be implemented, for example, as one or more circuits.

For example, the first and second LVDT signals could be provided to corresponding first and second demodulators 64 and 66 (labeled in FIG. 2 as “DMOD1” and “DMOD2”). Each of the first and second the demodulators 64 and 66 can provide first and second feedback signals to the FPGA 53. The first and second feedback signals could be implemented, for example, as DC signals. The FPGA 53 can apply a first feedback transfer function (G1(s)) 68 to the first feedback signal and a second feedback transfer function (G2(s)) 70 to the second feedback signal. The first and second feedback transfer functions 68 and 70 could be implemented, for example, as including a multi- (e.g., fourth) order filter, such as can be implemented as a difference equations. Equation 1 characterizes an example of a difference equation that could be employed as the first feedback transfer function 68. In a similar manner, Equation 1 could be employed to implement the second feedback transfer function 70 as well.

y[x[n]]=a₁*yₙ₋₁+a₂*yₙ₋₂+a₃*yₙ₋₃+a₄*yₙ₋₄+b₀*xₙ++b₁*xₙ₋₁+b₂*xₙ₋₂+b₃*xₙ₋₃+b₄*xₙ₋₄ Equation 1:

wherein:
x[n] is the first feedback signal;
y[x[n]] is a signal output by the first feedback transfer function 68 for a given input signal; and
a₁, a₂, a₃, a₄, b₀, b₁, b₂, b₃, b₄ are coefficients for the first feedback transfer function 68.

The FPGA 53 can also apply the output of the first and second feedback transfer functions 68 and 70 to respective first and second feedback gain blocks 72 and 74. Equation 2 characterizes an example of gain that could be applied by the first feedback gain block 72. In a similar manner, Equation 2 could be employed by the second feedback gain block 74 to apply the second feedback gain.

r[yₙ]=m*yₙ Equation 2:

wherein:
r[yₙ] is an output of the first feedback gain block 72;
yₙ is an output of the first feedback transfer function 68; and
m is a gain coefficient.

A computer 76 can be communicatively coupled to the FPGA 53. The computer 76 can include a memory 78 for storing machine readable instructions. The computer 76 can also include a processor unit 80 (e.g., a processor core) configured to access the memory 78 and execute the machine readable instructions. In some examples, the computer 76 can communicate with the FPGA 53 via a communications port such as a serial bus, a parallel port, a network port, or the like. A user can employ a user device 82 in communication with the computer 76 to interact with a graphical user interface (GUI) 84 to set the coefficients (e.g., parameters) of the first and second feedback transfer functions 68 and 70. The user device 82 could be implemented, for example, as a keyboard, a mouse, a combination thereof or the like. In a similar manner, the user device 82 can operate the GUI 84 to set the gain coefficient (e.g., parameters) for the first and second feedback gain blocks 72 and 74.

Additionally, in the example illustrated in FIG. 2, the FPGA 53 receives first and second feedback signals from the UUT 54 via the interface 62. However, the computer 76 can also be communicatively coupled to the interface 62 such that a user of the system 50 can employ the GUI 84 to provide a configuration signal that can selectively configure the source of the first and second feedback signals. For instance, in some examples, the feedback signals may not originate from an LVDT and/or may not be demodulated by the interface 62.

In some examples, the memory can store test data 85 that includes a sequence 87. In some examples, the sequence 87 can store the parameters and/or an order of command signals for the FPGA for a specific UUT 54 and/or a specific test. The sequence 87 can be associated with a set of parameters 89 that can also be stored in the test data. The parameters 89 can include, for example, data defining coefficients of feedback transfer functions 68 and 70, and/or gain coefficients for gain block 72 and 74 or the like. For instance, in some environments of application, the coefficients for the first and second feedback transfer functions 68 and 70 can be provided from the manufacturer of the UUT 54. One of ordinary skill in the art will understand and appreciate that other data could additionally or alternatively be included in the test data

The FPGA 53 can apply the output of the first and second feedback gain blocks 72 and 74 to a PID controller 86. Additionally, the FPGA 53 can receive a first and second command signal (labeled in FIG. 2 as “CMD 1” and “CMD 2”) from the computer 76. For instance, the test data 87 can be utilized to provide first and second command signals to corresponding inputs of the FPGA, such as based on the test data 87 for performing a test routine. In other examples, the first and second command signals could be provided from another source. The first and second command signals can be provided to corresponding first and second gain blocks 88 and 90. The first and second gain blocks 88 and 90 can apply first and second gains to the corresponding first and second command signals. In one example, Equation 3 could be employed by the first gain block 88 to apply a gain to the first command signal. In a similar manner, Equation 3 could be employed by the second gain block 90 to apply a gain to the second command signal.

l[cₙ]=m*cₙ Equation 3:

wherein:
l[cₙ] is an output of the first gain block 88;
cₙ is the first command signal; and
m is a gain coefficient.

A user can utilize the user device 82 to interact with the GUI 84 to set the gain coefficient (e.g., parameters) of the first gain block 88 and/or the second gain block 90. The outputs of the first and second gain blocks 88 and 90 can be provided to corresponding inputs of the PID controller 86 of the FPGA 53.

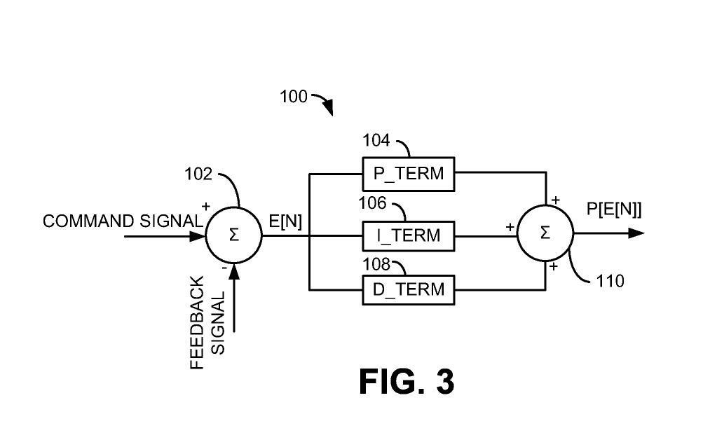

FIG. 3 illustrates an example of a PID controller 100 that could be employed as the PID controller 86 illustrated in FIG. 2. In FIG. 3, a first summing block 102 can subtract a feedback signal (labeled in FIG. 3 as “FEEDBACK SIGNAL”) from a command signal (labeled in FIG. 3 as “COMMAND SIGNAL”). The command signal could be implemented, for example, as a sum of the output of the first and second gain blocks 88 and 90 illustrated in FIG. 2. The feedback signal could be implemented, for example, as a sum of the output of the first and second feedback gain blocks 72 and 74 illustrated in FIG. 2. The first summing block 102 can provide an error signal (labeled in FIG. 3 as “E[N]”). The error signal can be provided to a proportional function block 104 to calculate a proportional term (labeled in FIG. 3 as “P_TERM”), an integral function block 106 to calculate an integral term (labeled in FIG. 3 as “I_TERM”) and a derivative function block 108 to calculate a derivative term (labeled in FIG. 3 as “D_TERM”).

The proportional function block 104 can employ Equation 4 to calculate the proportional term. The proportional term can make a change to an output that is proportional to a current error value. A high proportional term results in a large change in the output of the PID controller 100 for a given change in the error signal. If the proportional gain is too high, the system can become unstable. In contrast, a small proportional term results in a small output response to a large input error, and a less responsive or less sensitive PID controller 100. If the proportional term is too low, a resulting control action may be too small when responding to system disturbances.

Pₜₑᵣₘ[e[n]]=Kₚeₙ Equation 4:

wherein:
Kₚ is a proportional term constant;
e[n] is the error signal; and
Pₜₑᵣₘ[e[n]] is the proportional term for a given error signal.

As a further example, the integral function block 106 can employ Equation 5 to calculate the integral term. The contribution to the output of the PID controller 100 from the integral term is proportional to both the magnitude of the error signal and the duration of the error signal. The integral term in the PID controller 100 corresponds to the sum of an instantaneous error over time and gives an accumulated error. The accumulated error is then multiplied by an integral term constant (Kᵢ). The integral term accelerates movement of the process towards a setpoint and substantially eliminates residual steady-state error that could occur in a pure proportional controller. However, since the integral term responds to accumulated errors from the past, the proportional term can cause the present value to overshoot the setpoint value.

Iₜₑᵣₘ[e[n]]=[I_{term n-1}+(eₙ*Δt)]Kₜ Equation 5:

wherein:
Kᵢ is the integral term constant;
Δt is a change in time between n and n−1; and
Iₜₑᵣₘ[e[n]] is the integral term for a given error signal.

The derivative function block 108 can employ Equation 6 to calculate the derivative term. The derivative term can be calculated by determining the slope of the error signal over time and multiplying the rate of change of the error signal by a derivative gain K_{d}. The derivative term slows the rate of change of the controller output. The derivative term can be used to reduce the magnitude of the overshoot of the setpoint produced by the integral component and improve the combined controller-process stability. However, the derivative term slows the transient response of the PID controller 100. Additionally, the derivative term in the PID controller 100 is sensitive to noise in the error signal, which can cause the process to become unstable if the noise and the derivative term are sufficiently large.

Dₜₑᵣₘ[e[n]]=[(eₙ−eₙ₋₁)/Δt]K_{d} Equation 6:

wherein:
K_{d} is the integral term constant;
Δt is a change in time between n and n−1; and
Dₜₑᵣₘ[e[n]] is the integral term for a given error signal.

The PID controller 100 can employ a second summing block 110 that can aggregate the proportional term, the integral term and the derivative term together. Equation 7, can be employed by the second summing block 110 to calculate a PID output signal (labeled in FIG. 3 as “P[E[N]]”).

Equation 7:

P[e[n]]=Pₜₑᵣₘ+Iₜₑᵣₘ+Dₜₑᵣₘ

wherein:
P[e[n]] is the PID output signal for a given error signal.

Referring back to FIG. 2, a user can employ the user device 82 to interact with the GUI 84 to set a proportional term constant Kₚ, an integral term constant Kᵢ and/or a derivative term constant K_{d} of the PID controller 86. Moreover, in some environments of application, the PID controller 86 can be disabled in response to a user input received via the user device 82 of the computer 76. In such a situation, the output signal of the PID controller 86 could be equal to the error signal input therein. In one example, the PID controller 86 could be disabled by setting the proportional term constant Kₚ equal to one (‘1’) and setting the integral term constant Kᵢ and the derivative term constant K_{d} of the PID controller 86 to zero (‘0’). In other examples, the PID controller 86 can be omitted. In such a situation, a summing component that provides a signal corresponding to the difference in the command signals and the feedback signals can be provided in place of the PID controller 86. Such a disabling or omitting of the PID controller 86 could represent a configuration where no PID controller is necessary and/or desired.

An output of the PID controller 86 can be provided to a forward transfer function 92. The forward transfer function 92 can apply a transfer function to the output of the PID controller 86. In one example, the output of the forward transfer function 92 can be calculated with Equation 8.

f[pₙ]=a₁*fₙ₋₁+a₂*fₙ₋₂+a₃*fₙ₋₃+a₄*fₙ₋₄+b₀*pₙ+b₁* pₙ₋₁+b₂*pₙ₋₂+b₃*pₙ₋₃+b₄*pₙ₋₄ Equation 8:

wherein:
pₙ is the output of the PID controller 86;
f[pₙ] is the output of the forward transfer function 92 for a given pₙ; and
a₁, a₂, a₃, a₄, b₀, b₁, b₂, b₃ and b₄ are coefficients for the forward transfer function 92.

A user of the computer 76 can employ the GUI 84 to set the coefficients for the forward transfer function 92. In some environments of application the coefficients for the forward transfer function 92 can be provided from the manufacturer of the UUT 54 and stored, for example, in the test data 85. In other examples, the coefficients can be calculated and/or estimated based on a different transfer function. The FPGA 53 can provide the output of the forward transfer function 92 to a dither function block 94. The dither function block 94 can apply a dithering to the output of the transfer function. The dither function block 94 can have a frequency and a magnitude. The frequency and the magnitude of the dither function block 94 can be set in response to user input (e.g., provided via the user device 82) at the computer 76 provided via the GUI 84.

In one example, the frequency of the dither function block 94 can be set in a range of about 0 Hz to about 400 Hz. Moreover, in some examples, the magnitude of the dither can be set in a range from about 0 V to about 10 V. The output of the dither function block 94 can be provided as an output of the FPGA 53, which output can be referred to as a control signal. The control signal can be provided to a current driver 96 of the interface 62. The current driver 96 can provide the control current to the EHV 56, wherein control current can correspond to the output of the FPGA 53. In response to the control current, the EHV 56 can provide a response (e.g., a mechanical response). The first and/or the second LVDT signal can characterize the response to the EHV 56. In some examples, the GUI 84 of the computer 76 can provide an output to the user device 82 in the form of graphical indicia (e.g., a graph) that characterizes the response to the EHV 56. In this manner, the computer 76 can be programmed to measure and/or analyze the response to the EHV 56 based on the parameters set in the FPGA 53. The results can be stored in results data 98 and used to drive an output that can be presented to the user (e.g., via the GUI 84).

In some examples, user inputs (e.g., received via the user device 82) can employ the GUI 84 to change the arrangement of the feedback signals. For instance, in some examples, the user can employ the GUI 84 to change the sources of the feedback signals or what the feedback signals represent, such as may vary according to the context of the system being simulated.

Employment of the system 50 can allow the user to tune (e.g., set and/or change) parameters of the PID controller 86, the gain blocks 88 and 90, the feedback gain blocks 72 and 74, the transfer functions (the first and second feedback transfer functions 68 and 70 and the forward transfer function 92) and the dither function block 94. Such a tuning allows the system 50 to simulate a large range of stimuli (e.g., in the form of the control current) to the UUT 54.

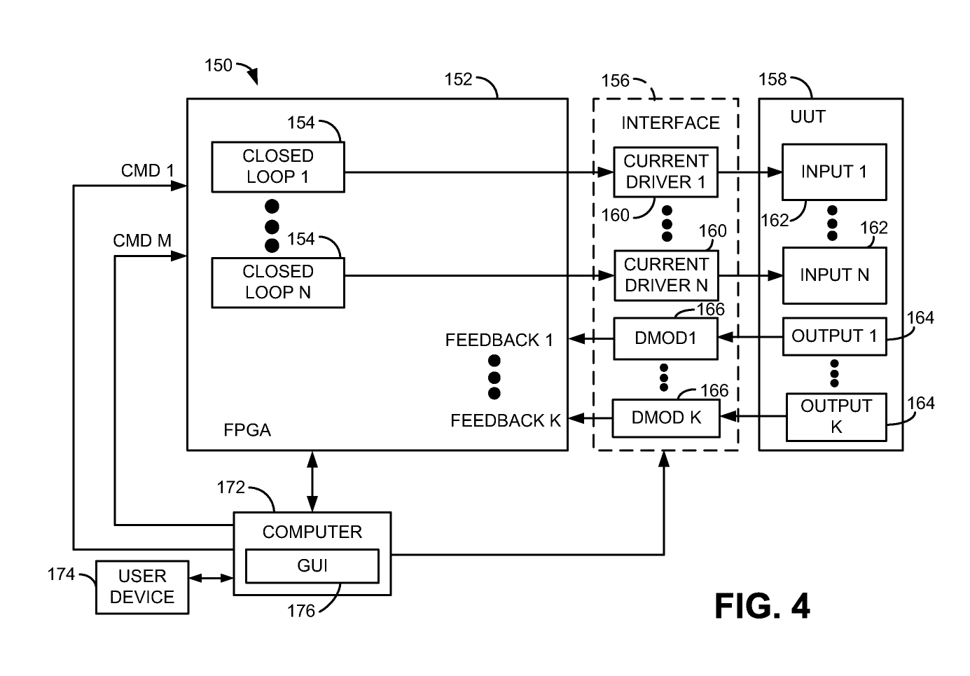

FIG. 4 illustrates an example of a test system 150 that includes an FPGA 152 with N number of closed loops 154, wherein N is an integer greater than or equal to one. The FPGA 152 could be implemented, in a manner similar to the FPGA 53 illustrated in FIG. 2. Moreover, each of the N number of closed loops 154 can be implemented with programmable transfer functions in a manner similar to the closed loop 52 illustrated in FIG. 2.

The FPGA 152 can receive M number of command signals (labeled in FIG. 4 as “CMD 1” and “CMD M”), where M is an integer greater than or equal to one. The M number of command signals can include, for example the first and second command signals described with respect to FIG. 2. The FPGA 152 can communicate with an interface 156 that provides stimuli to a UUT 158. In some examples, each of the N number of closed loops 154 can be associated with a corresponding current driver 160 of the interface 156. Additionally, each of the corresponding current drivers 160 can be associated with a corresponding input 162 of the UUT 158, such as an EHV (labeled in FIG. 4 as “INPUT 1” and “INPUT N”). The UUT 158 can provide K number of output signals from K number of outputs 164, such as could be implemented as LVDTs (labeled in FIG. 4 as “OUTPUT 1” and “OUTPUT K”) signals to corresponding K number of demodulators 166 (labeled in FIG. 4 as “DMOD1” and “DMODK”) of the interface 156, where K is an integer greater than or equal to one. Each of the K number of demodulators 166 can provide a corresponding feedback signal (labeled in FIG. 4 as “FEEDBACK 1” and “FEEDBACK K”). The LVDT signals can correspond to sensed parameters of the UUT 158.

The FPGA 152 and the interface 156 can communicate with a computer 172. The computer 172 can be implemented in a manner similar to the computer 76 illustrated in FIG. 2, and thus can be an integral part of the test system 150. The computer 172 can provide the plurality of command signals to the FPGA 152. A user of the computer 172 can interact with the computer via a user device 174 and employ a GUI 176 of the computer 172 to tune (e.g., set and/or change) transfer function parameters of each of the N number of closed loops 154. For instance, the user employ the user device 174 to interact with the GUI 176 to tune parameters of a PID controller, gain blocks, as well as other transfer function paths and a dither function in each of the N number of closed loops 154. Additionally, in some examples, the user can employ the user device 174 to interact with the GUI 176 to selectively monitor and analyze feedback signals for each of the N number of closed loops 154. Employment of the system illustrated in FIG. 4 allows multiple simulated stimuli (e.g., in the form of control currents) to be concurrently provided to multiple EHVs in the UUT 158, for example.

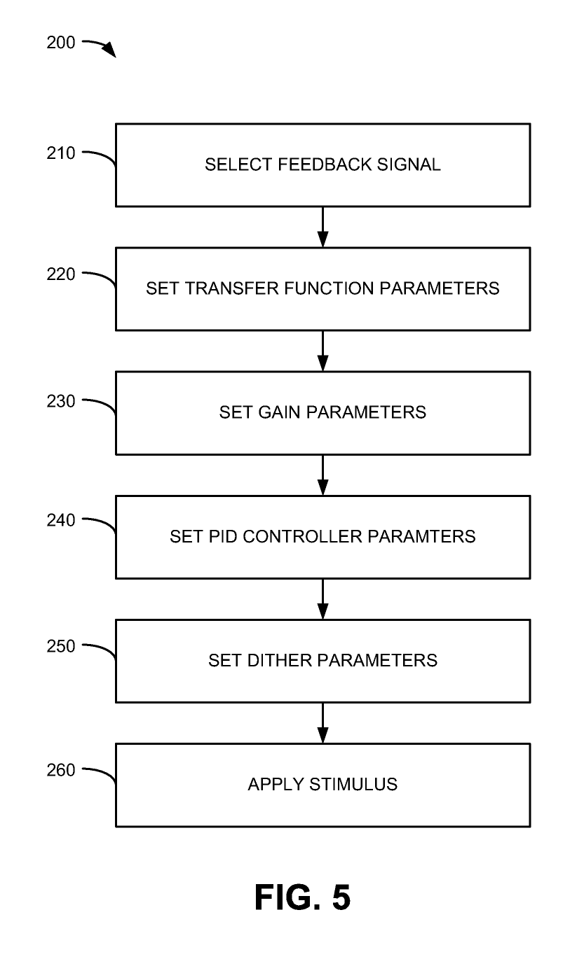

In view of the foregoing structural and functional features described above, example methods will be better appreciated with reference to FIG. 5. While, for purposes of simplicity of explanation, the example method of FIG. 5 is shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method.

FIG. 5 illustrates a flowchart of an example method 200 for configuring a closed loop. The method could be implemented, for example by the system 2 illustrated in FIG. 1 and/or the system 50 illustrated in FIG. 2. At 210, a user can employ a GUI of a computer to select a feedback signal for the closed loop of a controller, such as an FPGA, a microcontroller, an ASIC or the like. At 220, the user can employ the GUI to set transfer function parameters for the closed loop. The setting of the transfer function parameters can include, for example, setting and/or changing coefficients of difference equations feedback transfer functions (such as the first and second feedback transfer functions 68 and 70 in FIG. 2) and setting and/or changing coefficients of a forward transfer function (such as the forward transfer function 92 illustrated in FIG. 2). At 230, the user can employ the GUI (e.g., the GUI 84 illustrated in FIG. 2) to set gain parameters, such as a gain constant, for the feedback signal and a command signal. At 240, the user can employ the GUI to set PID controller parameters (e.g., proportional, integral and derivative constants) for a PID controller of the closed loop. The PID controller could be implemented in a manner similar to the PID controller 100 illustrated in FIG. 3.

At 250, the user can employ the GUI to set dithering parameters (e.g., magnitude and frequency) for a dither function (e.g., the dither function 94 illustrated in FIG. 2) of the closed loop. At 260, a stimulus can be applied to a UUT, such as the UUT 54 illustrated in FIG. 2. Application of the stimulus can include, for example, applying the command signal to the controller, which in turn can apply a control signal to a current source. The current source can apply a corresponding control current to an actuator (e.g., an EHV) of the UUT. The control current can be employed, for example to simulate stimuli to the UUT. What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A test system comprising:
a test controller configured to provide a closed loop, the closed loop comprising:
a forward transfer function with programmable coefficients that is configured to receive a command signal; and
a feedback transfer function having programmable coefficients and being configured to provide a feedback signal that is subtracted from the command signal;
wherein the test controller is configured to provide a control signal corresponding to an output of the forward transfer function.

2. The system of claim 1, wherein the test controller further comprises an FPGA.

3. The system of claim 1, the closed loop further comprises a proportional-integral-derivative (PID) controller with programmable proportional, integral and derivative parameters, an output of the PID controller being provided as an input to the forward transfer function.

4. The system of claim 1, wherein the closed loop further comprises a dither function that is configured to apply a dithering to an output of the forward transfer function, the dithering including a programmable frequency and magnitude.

5. The system of claim 1, wherein the feedback transfer function is a first feedback transfer function and the feedback signal is a first feedback signal, the closed loop further comprising a second feedback transfer function having programmable coefficients and being configured to provide a second feedback signal to the PID controller.

6. The system of claim 1, wherein the closed loop further comprises a programmable feedback gain block configured to apply gain to the feedback signal in response to a user input.

7. The system of claim 1, wherein the command signal comprises a plurality of command signals, and the system further comprising a command module configured to provide the plurality of command signals that control an output of the forward transfer function.

8. The system of claim 1, further comprising a current driver configured to receive the control signal from the FPGA, the current driver being configured to provide a control current to an output that corresponds to the output of the FPGA, the output configured to connect with a unit under test (UUT).

9. The system of claim 8, wherein the UUT comprises an electro-hydraulic valve (EHV) that is operated based on the control current.

10. The system of claim 9, wherein the UUT further comprises a linear variable differential transformer (LVDT) that is configured to provide a signal corresponding to the feedback signal based on a sensed parameter of the UUT.

11. The system of claim 10, wherein the signal provided by the LVDT corresponds to a position of the UUT actuator.

12. The system of claim 1, wherein the forward transfer function is configured such That
f[pₙ]=a₁*fₙ₋₁+a₂*fₙ₋₂+a₃*fₙ₋₃+a₄*fₙ₋₄+b₀*pₙ+b₁*pₙ₋₁+b₂*pₙ₋₂+b₃*pₙ₋₃+b₄*pₙ₋₄;
wherein:
pₙ denotes an input of the forward transfer function;
f[pₙ] denotes an output of the forward transfer function for a given pₙ; and
a₁, a₂, a₃, a₄, b₀, b₁, b₂, b₃ and b₄ denote the programmable coefficients of the forward transfer function.

13. The system of claim 12, wherein the reverse transfer function is configured such that:
y[x[n]]=a₁*yₙ₋₁+a₂*yₙ₋₂+a₃*yₙ₋₃+a₄*yₙ₋₄+b₀*xₙ+b₁*xₙ₋₁+b₂*xₙ₋₂+b₃*xₙ₋₃+b₄*xₙ₋₄
wherein:
x[n] denotes an input to the feedback transfer function;
y[x[n]] denotes a signal output by the feedback transfer function for a given input signal; and
a₁, a₂, a₃, a₄, b₀, b₁, b₂, b₃, b₄ are coefficients for the feedback transfer function.

14. The system of claim 1, wherein a source of the feedback signal is selectable.

15. The system of claim 1, wherein the closed loop comprises a plurality of closed loops, each of the plurality of closed loops having a programmable transfer function.

16. A test system for configuring a closed loop comprising:
a control system configured to provide a closed loop, the closed loop configured to receive at least one command signal and comprising:
a proportional-integral-derivative (PID) controller with programmable constants;
a forward transfer function with programmable coefficients that is configured to receive an output of the PID controller; and
a feedback transfer function having programmable coefficients and being configured to provide a feedback signal to the PID controller;
wherein the control system is configured to provide a control signal corresponding to an output of the forward transfer function;
an interface configured to provide an electrical signal to an output for operating a unit under test (UUT) as a function of the electrical signal.

17. The system of claim 16, wherein the interface further comprises a demodulator configured to demodulate the response signal and provide the feedback signal to the control system.

18. The system of claim 16, wherein the forward transfer function comprises a difference equation corresponding to a plurality of variables with coefficients.

19. The system of claim 16, wherein the closed loop comprises a plurality of closed loops.

20. A method for configuring a test system comprising:
selecting a feedback signal for a closed loop from a plurality of feedback signals;
setting transfer function parameters in a transfer function of a control system for the closed loop; and
setting proportional-integral-derivative (PID) controller parameters for a PID controller of the control system for the closed loop.

21. The method of claim 20, wherein the setting of the transfer function parameters further comprises:
setting coefficients for a difference equation corresponding to a forward transfer function; and
setting coefficients for a difference equation corresponding to a feedback transfer function of the control system for the closed loop, wherein an output of the feedback transfer function corresponds to an input of the PID controller.

22. The method of claim 21, further comprising setting dither parameters for a dither function of the control system for the closed loop, wherein an input to the dither function corresponds to an output of the forward transfer function.
